(19) United States
(12) Patent Application Publication
(10) Pub. No.: US 2022/0344845 A1
(43) Pub. Date: Oct. 27, 2022

(54) ELECTRICAL CONNECTOR INCLUDING AN INSERT-MOLDED BOTTOM FIXING MEMBER HAVING A BODY AND A PROTRUSION ENTIRELY BORDERED BY THE BODY

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: JUN ZHAO, HUAIAN (CN)

(21) Appl. No.: 17/724,903

(22) Filed: Apr. 20, 2022

(30) Foreign Application Priority Data
Apr. 21, 2021 (CN) 202110428340.4

(51) Int. Cl. H01R 12/72; H01R 13/516; H01R 12/58; H01R 13/405

(52) U.S. Cl. CPC H01R 12/722; H01R 13/516; H01R 12/58; H01R 13/405

(57) ABSTRACT

An electrical connector includes a metallic shell, an insulative housing received by the metallic shell, plural terminals retained in the insulative housing, an insulative cover receiving the metallic shell and the insulative housing, and a fixing member insert-molded at a bottom of the insulative cover, wherein the fixing member has a body and a protrusion entirely bordered by the body.

### BACKGROUND OF THE INVENTION

### 1. Field of the Invention

The present invention relates to an electrical connector comprising a metallic shell, an insulative housing received by the metallic shell, a plurality of terminals retained in the insulative housing, an insulative cover receiving the metallic shell and the insulative housing, and a fixing member insert-molded at a bottom of the insulative cover for mounting to a printed circuit board.

### 2. Description of Related Art

U.S. Pat. No. 8,827,742 discloses an electrical connector comprising a metallic shell, an insulative housing received by the metallic shell, a plurality of terminals retained in the insulative housing, an insulative cover receiving the metallic shell and the insulative housing, and a fixing member insert-molded at a bottom of the insulative cover. The insert-molded fixing member has a rectangular body portion and a pair of stamped and formed portions bent downwardly from respective inner edges of the body portion. Since the pair of stamped and formed portions are each connected at one end thereof to the body portion, an insert-molding operation to combine the fixing member at the bottom of the insulative cover is difficult to perform. Namely, it is difficult for a molding tool or core to match the contour of the pair of stamped and formed portions such that spilling of plastic materials during molding is apt to occur, or the pair of stamped and formed portions are prone to deform.

An electrical connector having an improved fixing member is desired.

### SUMMARY OF THE INVENTION

An electrical connector comprises: a metallic shell; an insulative housing received by the metallic shell; a plurality of terminals retained in the insulative housing; an insulative cover receiving the metallic shell and the insulative housing; and a fixing member insert-molded at a bottom of the insulative cover, wherein the fixing member has a body and a protrusion entirely bordered by the body.

### BRIEF DESCRIPTION OF THE DRAWINGS

FIG. 1 is a perspective view of an electrical connector in accordance with the present invention mounted to a printed circuit board (PCB);

FIG. 2 is a perspective view of the electrical connector separated from the PCB;

FIG. 3 is a perspective view of the electrical connector;

FIG. 4 is another perspective view of the electrical connector;

FIG. 5 is an exploded view of a part of the electrical connector;

FIG. 6 is a view similar to FIG. 5 but from a different perspective;

FIG. 7 is an exploded view of the electrical connector;

FIG. 8 is a view similar to FIG. 7 but from a different perspective; and

FIG. 9 is a cross-sectional view of the electrical connector taken along line A-A in FIG. 1.

### DETAILED DESCRIPTION OF THE PREFERRED EMBODIMENT

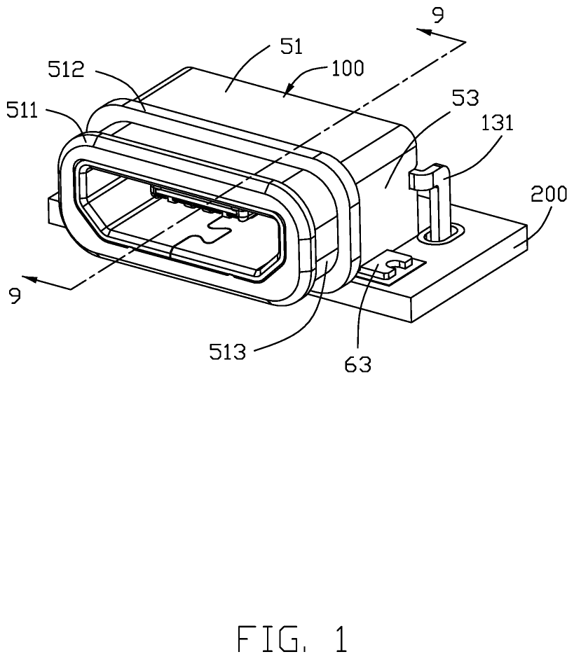

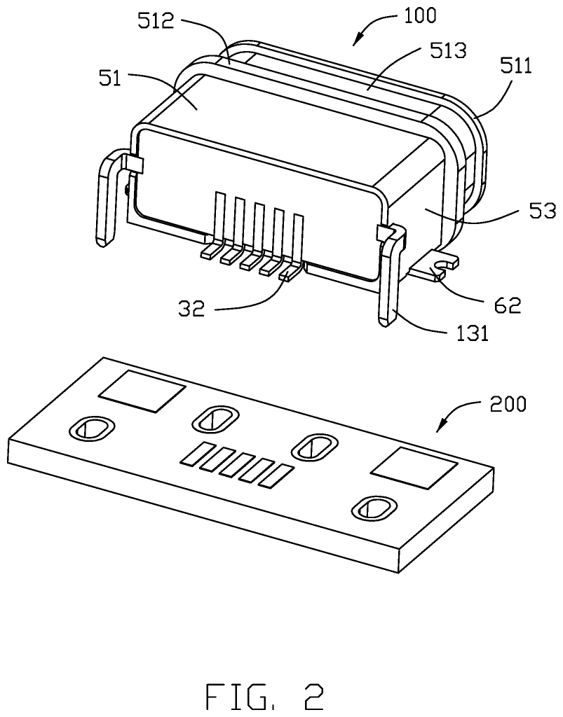

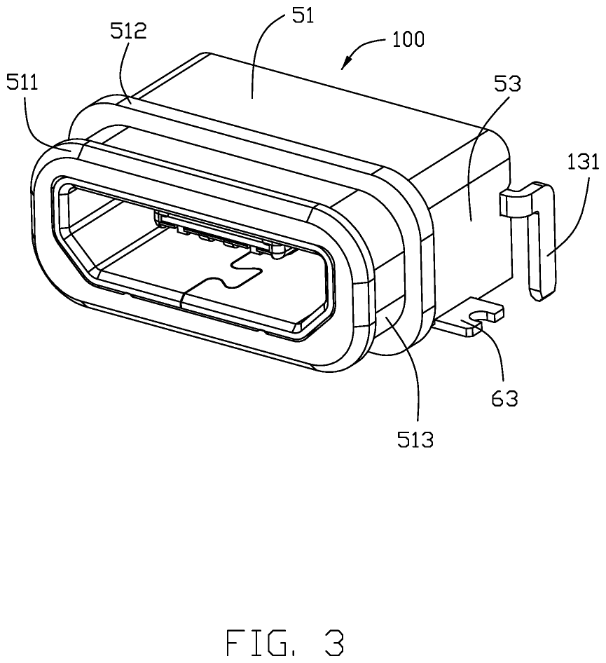

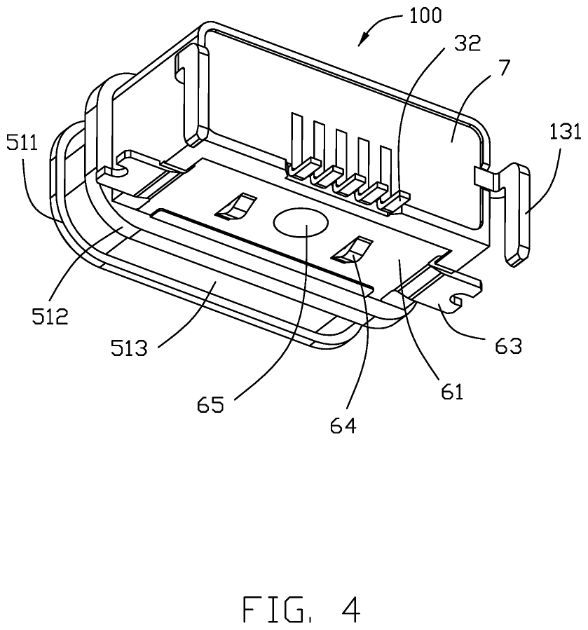

Referring to FIGS. 1-9, an electrical connector 100 for mounting to a PCB 200 includes a metallic shell 1, an insulative housing 2 received by the metallic shell 1, a plurality of terminals 3 retained in the insulative housing 2, an insulative cover 5 receiving the metallic shell 1 and the insulative housing 2, and a fixing member 6 insert-molded at a bottom of the insulative cover 5. The electrical connector 100 may further include a metal plate 4 secured to the insulative housing 2 and a rear waterproof sealer 7.

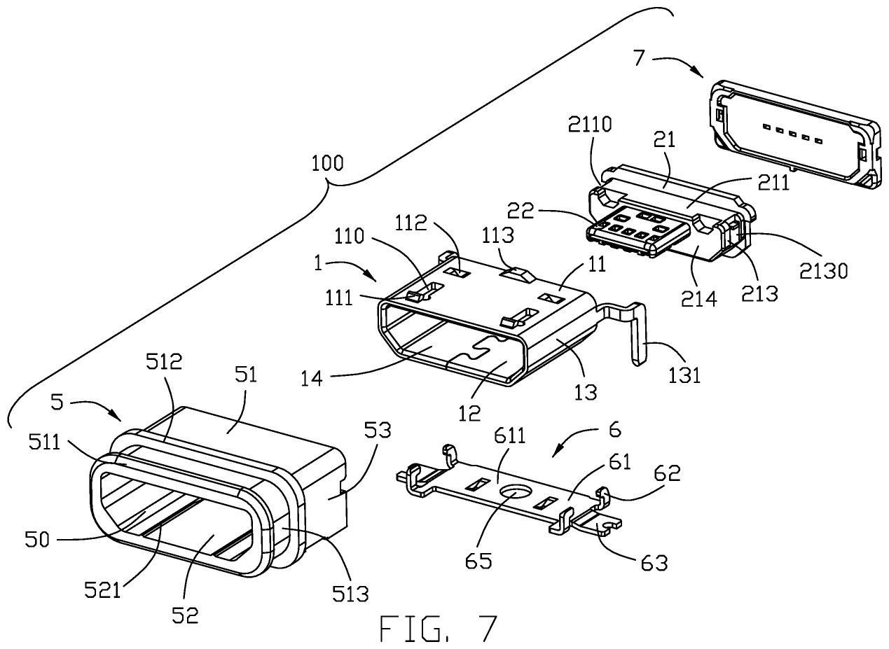

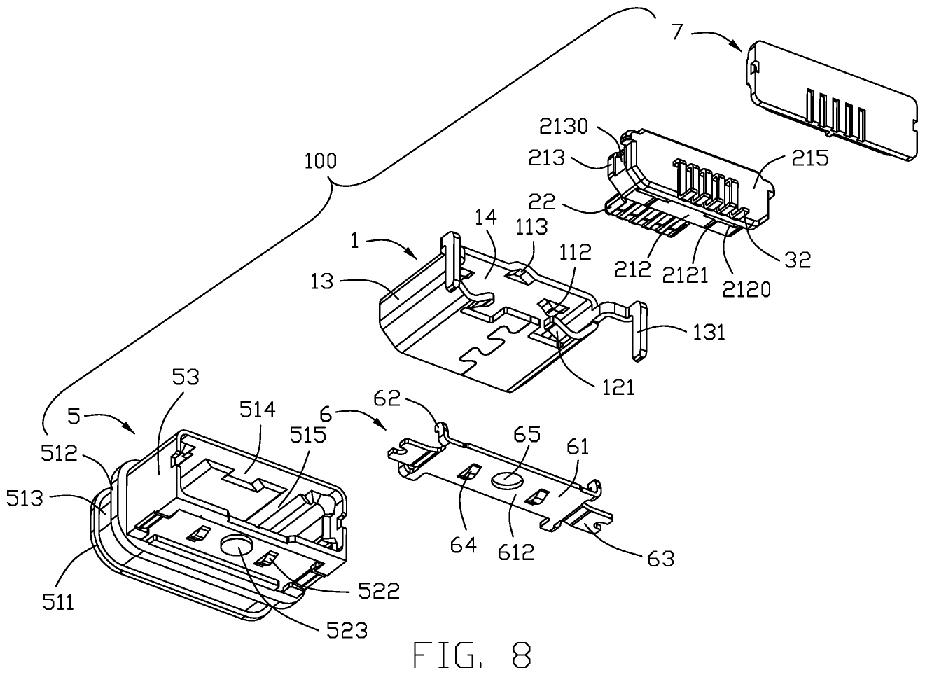

Referring in particular to FIGS. 7 and 8, the metallic shell 1 has a top wall 11, a bottom wall 12, and a pair of side walls 13 to define a receiving space 14 for inserting a complementary electrical connector. Each of the side walls 13 has a leg 131 for securing to the PCB 200.

The top wall 11 has a pair of holes 110 and corresponding stubs 111, a pair of first abutments 112, and a second abutment 113. The bottom wall 12 has a pair of stops 121. These components function or interact with other components in a well known manner to those skilled in this art so their detailed descriptions are omitted herein as well as omitted in the following descriptions for generally well known components.

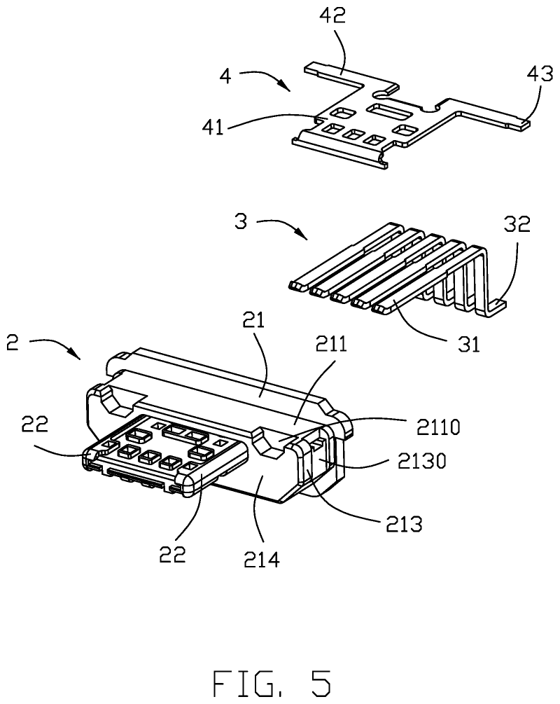

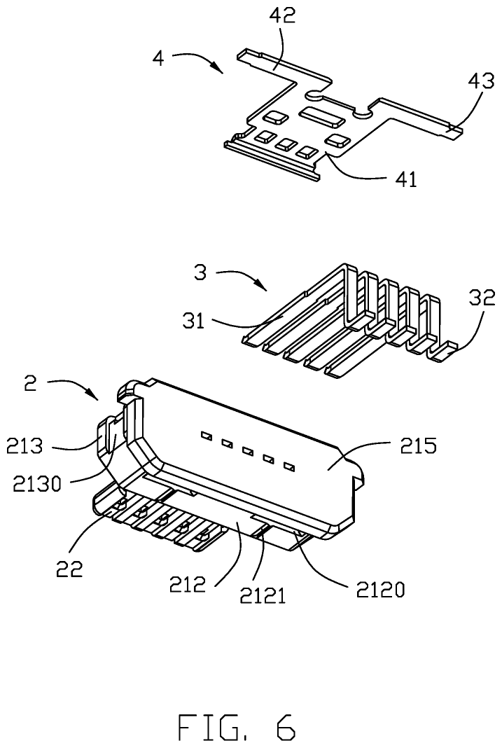

Referring in particular to FIGS. 5 and 6, the insulative housing 2 has a base 21 and a tongue 22. The base 21 has an upper surface 211, a lower surface 212, a pair of side surfaces 213, a front surface 214, and a rear surface 215.

The upper surface 211 has a pair of notches 2110 opening to the front surface 214. The lower surface 212 has a pair of slots 2120. The pair of side surfaces 213 has grooves 2130. The lower surface 212 further has a pair of ribs 2121.

The terminals 3 are insert-molded with the insulative housing 2. Each terminal 3 has a contacting portion 31 exposed to the tongue 22 and a tail 32 extending rearwardly of the rear surface 215. The metal plate 4 is also insert-molded with the insulative housing 2 and includes a reinforcing portion 41, a securing portion 42, and a positioning portion 43.

Referring again to FIGS. 1-8, the insulative cover 5 has a top wall 51, a bottom wall 52, and a pair of side walls 53 to define a receiving chamber 50. The insulative cover 5 has a first ring 511 and a second ring 512 to define an annular space 513. The top wall 51 has a slot 514 and a pair of grooves 515 at an inner surface thereof. The bottom wall 52 has a pair of ribs 521 at an inner surface thereof. The bottom wall 52 has a pair of protuberances 522 and a block 523 at an outer surface thereof for a better securement between the insulative cover 5 and the fixing member 6.

Referring in particular to FIGS. 7 and 8 again, the fixing member 6 has a body 61, anchors 62 at four corners of the body 61 to be embedded in the insulative cover 5, a pair of soldering pads 63 extending laterally from the body 61 outwardly of the insulative cover 5, and a pair of protrusions 64 stamped out to bulge downwardly. The body 61 is substantially flat and has an upper face 611 and a lower face 612. Each of the protrusions 64 is formed by a shearing operation, in contrast to a blanking and bending operation, to have two opposite ends continuing the body 61 and an intermediate portion therebetween so that each protrusion 64 is entirely bordered by the body 61. The intermediate portion has two opposite faces substantially parallel to each other and adapted to engage two opposite side wall faces of plated through holes provided on the PCB 200. The intermediate portion may or may not be separated from the body 61; in the case of separation, the extent is so small that spilling of plastic materials during molding would not occur.

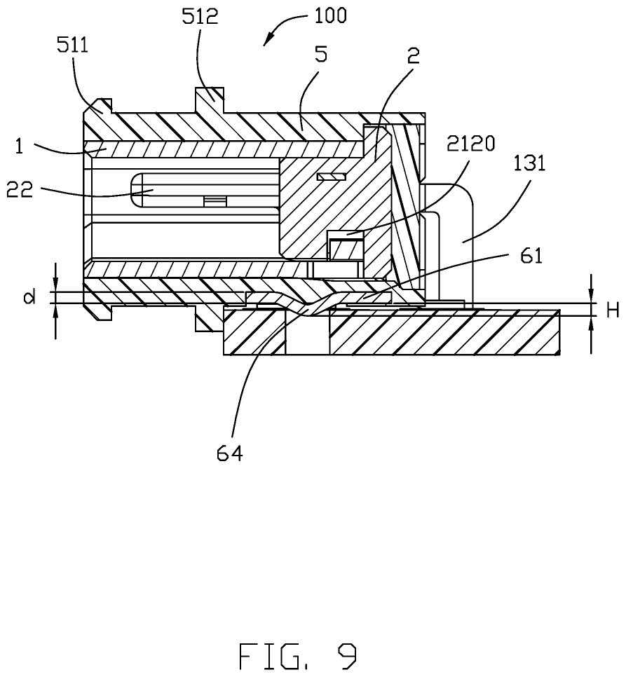

Referring in particular to FIG. 9, this embodiment shows a height H of the protrusion 64 as measured from the lower face 612 of the body 61 to a lowest point of the protrusion 64 is less than or equal to a thickness d of the protrusion 64. A molding operation to integrate the fixing member 6 with the insulative cover 5 is greatly simplified since the protrusions 64 are not required to match molding tools or cores. The lower face 612 of the body 61 is exposed to exterior. The body 61 has a hole 65 receiving the block 523. The protuberances 522 fill up the voids created by formation of the protrusions 64.

What is claimed is:

1. An electrical connector comprising:
a metallic shell;
an insulative housing received by the metallic shell;
a plurality of terminals retained in the insulative housing;
an insulative cover receiving the metallic shell and the insulative housing; and
a fixing member insert-molded at a bottom of the insulative cover; wherein
the fixing member has a body and a protrusion entirely bordered by the body.

2. The electrical connector as claimed in claim 1, wherein the protrusion of the fixing member is formed by a shearing operation to have two opposite ends continuing the body and an intermediate portion, the intermediate portion having two opposite faces substantially parallel to each other.

3. The electrical connector as claimed in claim 1, wherein the body of the fixing member is substantially flat.

4. The electrical connector as claimed in claim 1, wherein the fixing member has a pair of soldering pads extending laterally from the body outwardly of the insulative cover.
